(19) United States
(12) Patent Application Publication
(10) Pub. No.: US 2013/0229123 A1
(43) Pub. Date: Sep. 5, 2013

(54) LIGHTING-DIMMING DEVICE CHOPPING POWER WAVEFORMS FOR ADJUSTING BRIGHTNESS

(71) Applicants: Tain-Rein CHEN, Hsinchu (TW); Wan-Jung LIN, Hsinchu (TW); Chien-Cheng KUO, Hsinchu (TW)

(72) Inventors: Tain-Rein CHEN, Hsinchu (TW); Wan-Jung LIN, Hsinchu (TW); Chien-Cheng KUO, Hsinchu (TW)

(21) Appl. No.: 13/562,474

(22) Filed: Jul. 31, 2012

(30) Foreign Application Priority Data
Mar. 3, 2012 (TW) 101107154

(51) Int. Cl. H05B 37/02

(52) U.S. Cl. 315/201; 315/210

(57) ABSTRACT

A lighting-dimming device has a dimming module with an encoding function and at least one light module with a decoding function and controlled by the dimming module. The dimming module is designated with a required brightness and address command by a user. A triode AC switch of the dimming module is controlled to chop a power based on the required brightness and address command. The chopped power is transmitted to the light module to control the brightness of the light module. In the chopped power, only a part of cycles of the power is chopped and most of the power waveforms are maintained. Therefore, a high power factor is maintained.

### BACKGROUND OF THE INVENTION

1. Field of the Invention

The present invention relates to a lighting-dimming device, especially to a lighting-dimming device that chops power waveforms to produce a dimming signal for adjusting brightness.

2. Description of Related Art

Saving electrical energy is very important for environment protection. Nowadays, people use many electrical products, wherein fluorescent lamps are widely applied in daily life. LED lighting devices gradually substitute for the fluorescent lamps and incandescent lamps for responding to the environment protection. Dimmers are required for adjusting brightness of lighting devices.

With reference to FIG. 9, a conventional dimmer for adjusting brightness of a lighting device 91 comprises a diode AC switch (DIAC), a triode AC switch (TRIAC), a variable resistor VR1, a resistor R2, and a capacitor C1. A time-delay circuit is formed by the variable resistor VR1, the resistor R1 and the capacitor C1. The time-delay circuits determine a conducting time of the DIAC that further controls a conducting time of the TRIAC. When the DIAC and the TRIAC are conducted, the power waveforms of a received sine AC power can be chopped by the DIAC and the TRIAC.

The dimmer is connected to a driver 90 and outputs the chopped power to the driver 90. The driver 90 is connected to the lighting device 91 for driving and adjusting the brightness of the lighting device 91. The more the sine AC power is chopped, the lower the brightness of the lighting device 91 is. On the other hand, if only little sine AC power is chopped, the driver 90 can output higher energy in average to increase brightness of the lighting device 91.

When the said dimmer is applied to conventional bulbs or LED lighting devices, the power factor is decreased because the received power in each duty of time has been chopped. How to maintain the power factor without significantly changing an original wiring system is an essential issue.

Moreover, the conventional dimmer is an analog-based device using a variable resistor for dimming. The dimmer cannot be applied to an advanced user interface or for a long distance dimming. For an illuminating system with multiple lighting devices, the dimmer is unable to adjust each of the lighting devices separately.

### SUMMARY OF THE INVENTION

An objective of the present invention is to provide a lighting-dimming device capable of maintaining a high power factor.

To achieve the above-mentioned objective, the lighting-dimming device comprises:

a dimming module comprising:
a converter outputting a voltage signal in response to a dimming and addressing command;
a quantizer receiving the voltage signal output from the converter and outputting a brightness and address signal in response to the voltage signal;
an encoder producing an encoded signal corresponding to the brightness and address signal; and
a triode AC switch controlled by the encoded signal to turn on and off for chopping a power, wherein the power is chopped only during a part of cycles to represent the brightness and address signal; and

at least one light module receiving the chopped power, connected to the dimming module and comprising:
a decoder generating a combination signal based on the chopped power;
a driver generating a driving signal based on the combination signal; and

an illuminating unit connected to the driver and controlled by the driving signal to produce light with required brightness.

The dimming module receives an input power and a brightness and address command from a user interface input by a user. The encoder of the dimming module outputs an encoded signal corresponding to the brightness and address command to change a conducting time of the TRIAC and thus to produce a chopped power.

When the decoder of the at least one light module receives the chopped power, a combination signal is generated based on the chopped power and outputted to the driver for driving the illuminating unit to generate light with required brightness corresponding to the brightness and address command. In the present invention, only the power during a part of multiple continuous cycles is chopped. Therefore, the chopped power still remains in the original state substantially without obvious deformations. The power factor is accordingly kept high. Further, the user can easily and conveniently install or replace the lighting-dimming device of the present invention without changing an original wiring system in a house.

### BRIEF DESCRIPTION OF THE DRAWINGS

FIG. 1 is a block diagram of the present invention;

FIG. 2 is a block diagram of a dimming module of the present invention;

FIG. 3 is a block diagram of a light module of the present invention;

FIG. 4A is a waveform chart of a rectified full-wave power of the present invention;

FIG. 4B is a waveform chart of a first embodiment of an encoded signal output from the encoder of the present invention;

FIG. 4C is a waveform chart of a chopped power corresponding to FIG. 4B of the present invention;

FIG. 4D is a schematic view of a combination signal of the present invention;

FIG. 5 is a table showing different data codes that represent different levels of brightness of the present invention;

FIG. 6 is a block diagram of multiple dimming modules connected with multiple light modules of the present invention;

FIG. 7A is a waveform chart of a full-wave power;

FIG. 7B is a waveform chart of a second embodiment of an encoded signal output from the encoder of the present invention;

FIG. 7C is a waveform chart of a chopped power corresponding to FIG. 7B of the present invention;

FIG. 8 is a waveform chart of a third embodiment of chopped power of the present invention; and

FIG. 9 is a block diagram of a conventional dimming circuit.

### DETAILED DESCRIPTION OF PREFERRED EMBODIMENT

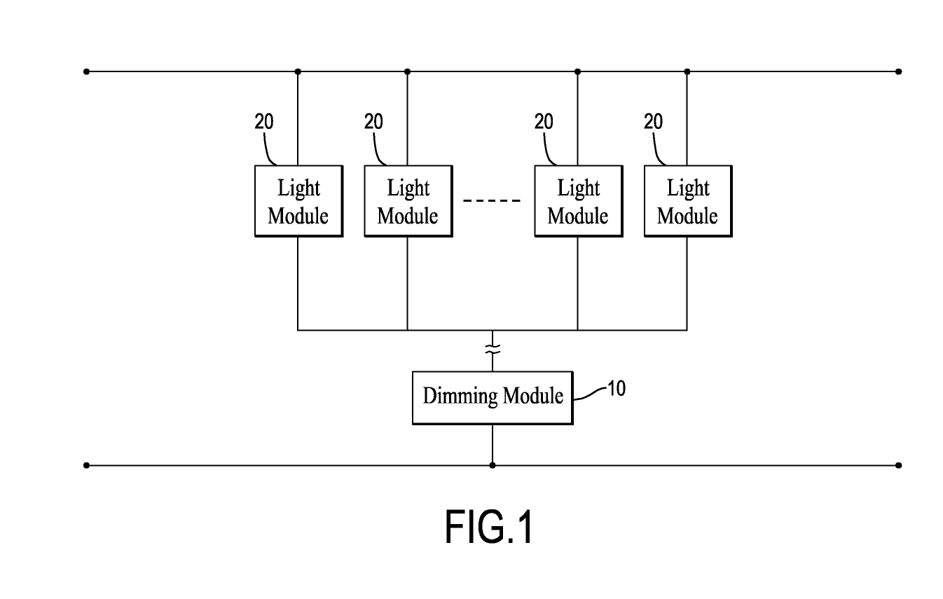

With reference to FIG. 1, the lighting-dimming device comprises a dimming module 10 and at least one light module 20 such as an LED lighting device that is installed on ceilings and connected to the dimming module 10 in series. The dimming module 10 in this embodiment is mounted in a switch panel of a wall-mounted switch.

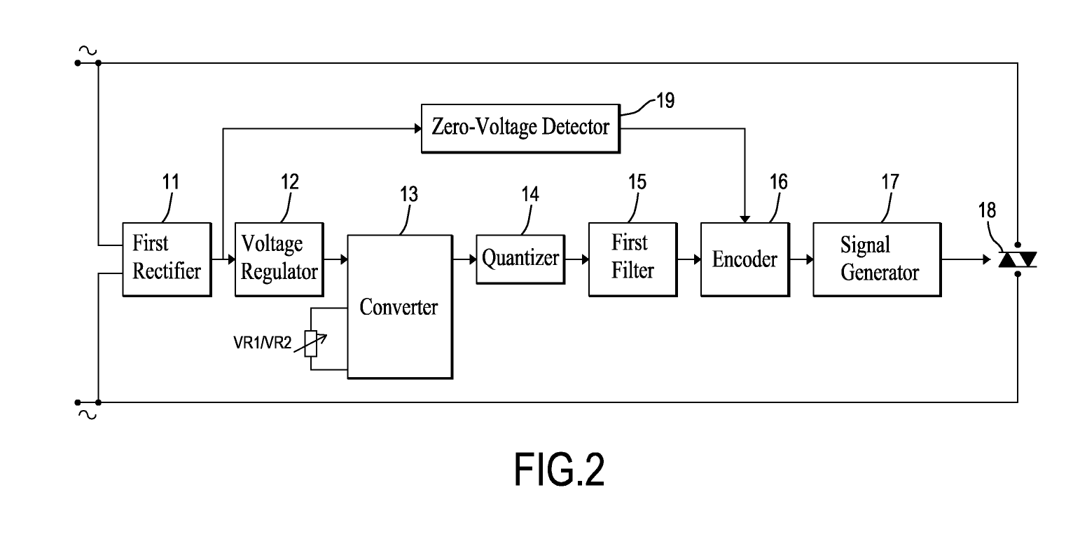

With reference to FIG. 2, the dimming module 10 comprises a first rectifier 11, a voltage regulator 12, a converter 13, a quantizer 14, a first filter 15, an encoder 16, a signal generator 17, a triode AC switch (TRIAC) 18 and a zero-voltage detector 19.

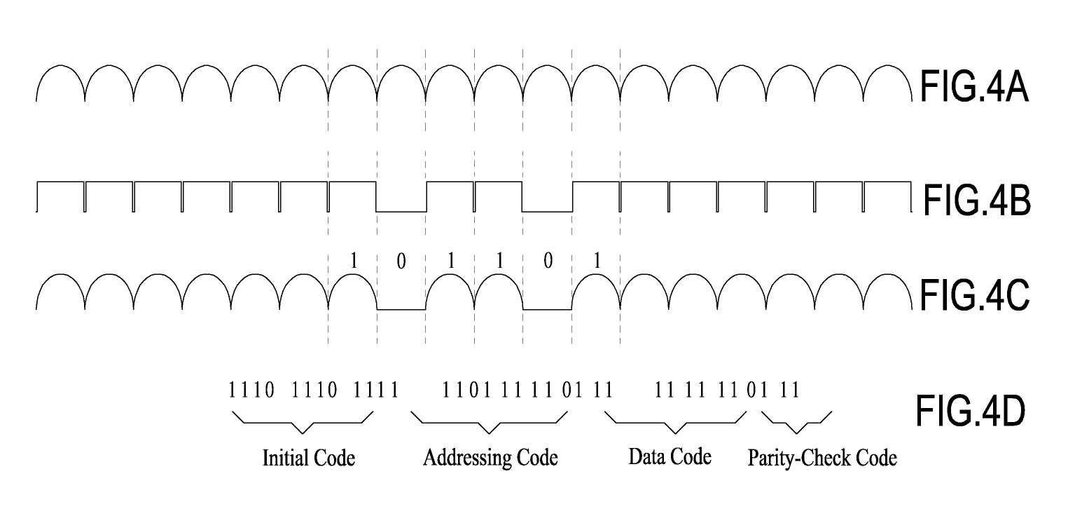

The first rectifier 11 has two input terminals connected to two lines of a wall-mounted switch to receive a sine AC power. The first rectifier 11 outputs a rectified full-wave power as shown in FIG. 4A to the voltage regulator 12. The voltage regulator 12 outputs a stabilized operating voltage.

The converter 13 outputs a voltage signal to the quantizer 14 in response to a dimming and addressing command. In this embodiment, the converter 13 outputs a voltage signal to the quantizer 14 under the control of two variable resistors VR1 and VR2. The two variable resistors VR1 and VR2 are configured in association with the wall-mounted switch, so a user can indirectly adjust the variable resistors VR1 and VR2 via the wall-mounted switch to control the voltage signal output from the converter 13. In other words, the dimming and addressing command is implemented by adjusting the variable resistors VR1 and VR2 so as to control the converter 13 to output a required voltage signal.

The quantizer 14 outputs a brightness and address signal corresponding to the voltage signal to the first filter 15. The first filter 15 filters noise of the brightness and address signal and then outputs the brightness and address signal to the encoder 16. Upon reception of the brightness and address signal, the encoder 16 refers to a built-in database to produce a corresponding encoded signal and then outputs the encoded signal to the signal generator 17. The signal generator 17 outputs a square signal to the TRIAC 18 to control a conducting time of the TRIAC 18. With the foregoing circuit operations, a chopped power corresponding to the encoding signal can be generated.

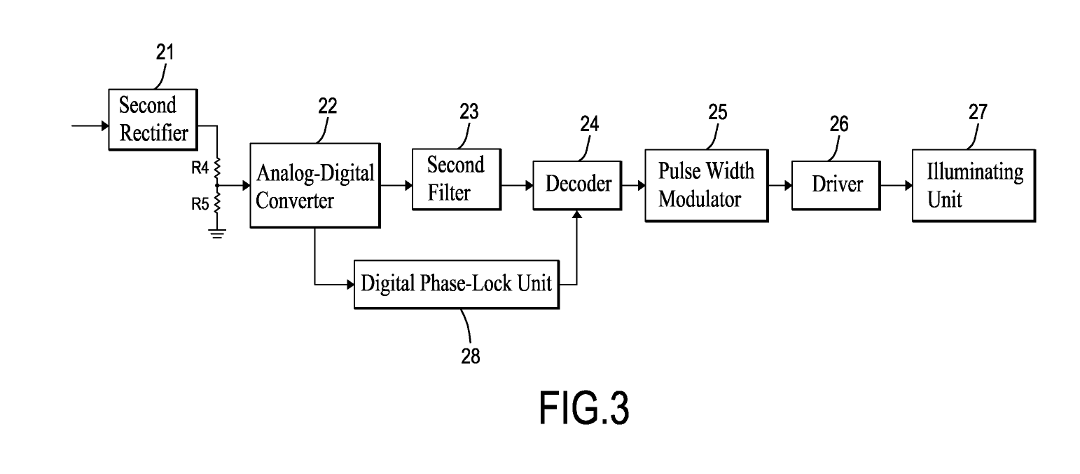

With reference to FIG. 3, the light module 20 in the first embodiment includes a second rectifier 21, an analog-digital converter 22, a second filter 23, a decoder 24, a pulse width modulator 25, a driver 26 and an illuminating unit 27 connected in series, and further includes a digital phase-lock unit 28 connected between the analog-digital converter 22 and the decoder 24.

When the second rectifier 21 receives the chopped power and rectifies the chopped power to a full-wave chopped power, the analog-digital converter 22 converts the chopped power to a digital signal. After noise of the digital signal is filtered by the second filter 23, the digital signal is outputted to the decoder 24 for decoding. The decoder 24 decodes the digital signal to a combination signal including an initial code, an address code, a data code and a parity-check code as shown in FIG. 4D. The combination signal is represented by “1” and “0” respectively corresponding to a high potential and a low potential of the chopped power. The combination signal is outputted to the pulse width modulator 25. The pulse width modulator 25 receives the combination signal and accordingly generates a pulse width modulation (PWM) signal output to the driver 26. Therefore, the driver 26 outputs a driving signal to control the illuminating unit 27 to generate required brightness. The digital phase-lock unit 28 receives the digital signal from the analog-digital converter 22 for the purpose of synchronization.

With reference to FIG. 2, an output terminal of the first rectifier 11 is connected to the zero-voltage detector 19. The function of the zero-voltage detector 19 is to ensure that encoded signal will be synchronized with the rectified full-wave signal. The voltage regulator 12 also provides the operating power required by the dimming module 10. The user can control an operating interface, such as the variable resistors VR1/VR2 or other interfaces, of the converter 13 to generate an adjusting signal to the quantizer 14.

When the user adjusts the converter 13 of the dimming module 10, for example via adjusting the variable resistors VR1/VR2 to produce a required voltage, the quantizer 14 accordingly generates the brightness and address signal. The encoder 16 generates the encoded signal corresponding to the brightness and address signal as shown in FIG. 4B by referring to the built-in database. The encoder 16 outputs the encoded signal to the TRIAC 18. With reference to FIG. 4C, by turning on and off the TRIAC 18, the chopped power is produced. When the light module 20 receives the chopped power, the decoder 24 based on the chopped power produces the combination signal output to the pulse width modulator 25. Then the pulse width modulator 25 outputs the PWM signal to the driver 26. The driver 26 outputs the driving signal to control the illuminating unit 27 to generate required brightness.

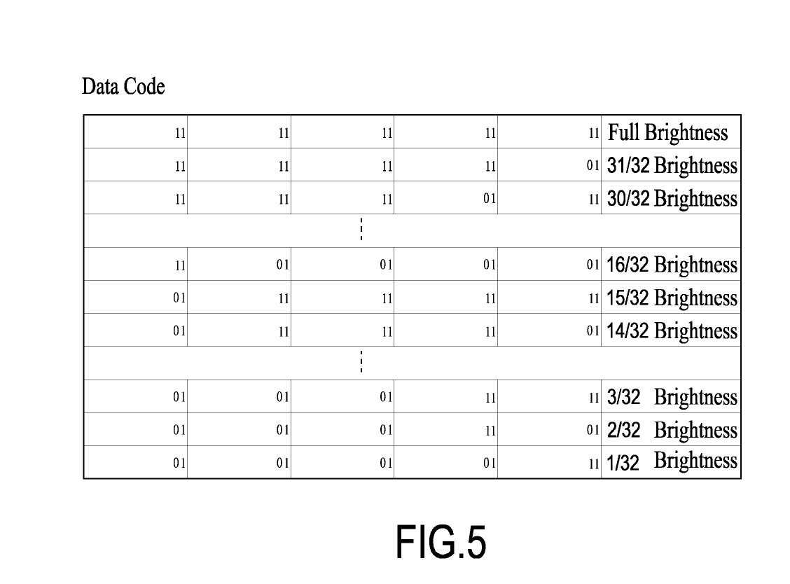

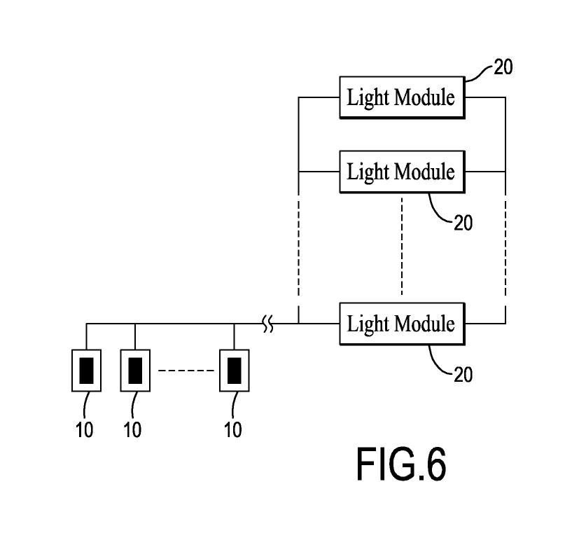

With reference to FIG. 5, the brightness of the illuminating unit 27 is decided by the data code. In this embodiment, the lighting-dimming device can generate 32 levels of brightness. With reference to FIG. 6, multiple dimming modules 10 in parallel are connected to multiple light modules 20 in parallel. The quantizers 14 of these dimming modules 10 can be designated with different address codes as their ID codes respectively. The light modules 20 having a matched ID will be controlled by a corresponding dimming module 10. In another aspect, a single dimming module 10 can simultaneously control multiple light modules 20 which have the same ID corresponding to the dimming module 10. If there are multiple dimming modules 10, different groups of the light modules 20 can be respectively and correspondingly controlled by the multiple dimming modules 10.

In the present invention, only the AC power in a part of cycles has been chopped. The AC power can remain in the original state substantially without significant deformations. Therefore, in comparison to the conventional light dimming approach, the power factor in accordance with the present invention will be kept high. The lighting-dimming device of the present invention can be applied to dim the illuminating devices in the building without changing the original wiring system.

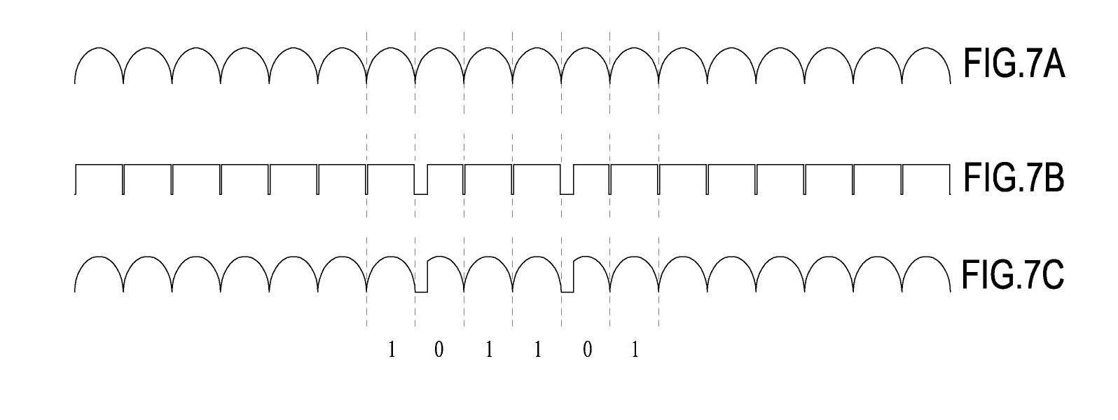

With reference to FIGS. 7A to 7C, the present invention provides a second embodiment of the chopped power. FIG. 7A shows a positive sine power. FIG. 7B is a driving signal output by the encoder 16 to control the TRIAC 18. By turning on and off the TRIAC 18, the positive sine power is adjusted as shown in FIG. 7C, wherein the power is chopped during a part of cycles. The conducting time of the TRIAC 18 determines the waveforms of the chopped power. The decoder 24 identifies the cycle with complete power as “1” and identifies the cycle with the chopped power as “0”. The chopped portion in each cycle of the second embodiment is less than that of the first embodiment. Therefore, the power factor of the second embodiment is higher than the first embodiment.

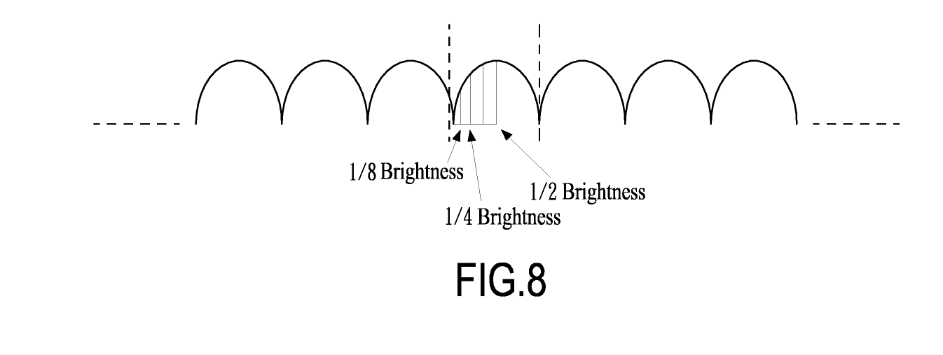

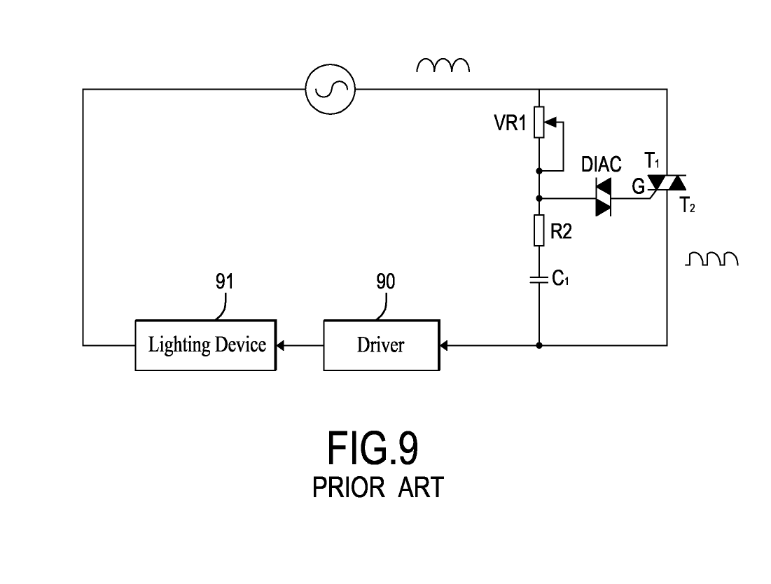

FIG. 8 is a third embodiment of the present invention. The power can be chopped in accordance with a required phase angle. The different phase angles can be interpreted as different data codes. For example, when a half portion of a waveform in a cycle is chopped, the chopped cycle will be interpreted to represent 50% of full brightness. When one-eighth portion of a waveform in a cycle is chopped, the chopped cycle will be interpreted to represent seven-eighths of full brightness. This embodiment chops only a portion of a single cycle. Therefore, energy loss of this embodiment is much lower than those of the first embodiment and second embodiment to maintain a higher power factor.

What is claimed is:

1. A lighting-dimming device chopping power waveforms for adjusting brightness, the lighting-dimming device comprising:
a dimming module comprising:
a converter outputting a voltage signal in response to a dimming and addressing command;
a quantizer receiving the voltage signal output from the converter and outputting a brightness and address signal in response to the voltage signal;
an encoder producing an encoded signal corresponding to the brightness and address signal; and
a triode AC switch controlled by the encoded signal to turn on and off for chopping a power, wherein the power is chopped only during a part of cycles to represent the brightness and address signal; and
at least one light module receiving the chopped power, connected to the dimming module and comprising:
a decoder generating a combination signal based on the chopped power;
a driver generating a driving signal based on the combination signal; and
an illuminating unit connected to the driver and controlled by the driving signal to produce light with required brightness.

2. The lighting-dimming device as claimed in claim 1, wherein:
the brightness and address signal outputted by the quantizer is a digital signal; and
the dimming module further comprises a signal generator connected between the encoder and the triode AC switch and producing a square signal to the triode AC switch based on the encoded signal.

3. The lighting-dimming device as claimed in claim 2, wherein the dimming module further comprises:
a first rectifier receiving a sine AC power and rectifying the sine AC power to a rectified full-wave power; and
a voltage regulator connected between the first rectifier and the converter, receiving the rectified full-wave power from the first rectifier, and providing a stabilized operating voltage.

4. The lighting-dimming device as claimed in claim 1, wherein the dimming module further comprises:
a first filter connected between the quantizer and the encoder for filtering noise of the brightness and address signal; and
a zero-voltage detector connected between an output terminal of the first rectifier and the encoder for synchronizing the encoded signal with the rectified full-wavepower.

5. The lighting-dimming device as claimed in claim 3, wherein the dimming module further comprises:
a first filter connected between the quantizer and the encoder for filtering noise of the brightness and address signal; and
a zero-voltage detector connected between an output terminal of the first rectifier and the encoder for synchronizing the encoded signal with the rectified full-wavepower.

6. The lighting-dimming device as claimed in claim 1, wherein the light module further comprises:
an analog-digital converter converting the chopped power to a digital signal output to the decoder; and
a pause width modulator connected between the decoder and the driver for producing a pulse width modulation (PWM) signal based on the combination signal from the decoder.

7. The lighting-dimming device as claimed in claim 6, wherein the light module further comprises a second rectifier receiving the chopped power and converting the chopped power to a full-wave chopped power.

8. The lighting-dimming device as claimed in claim 7, wherein the light module further comprises:
a second filter connected between the analog-digital converter and the decoder for filtering noises of the digital signal; and
a digital phase-lock unit connected between the analog-digital converter and the decoder for synchronizing the combination signal with the digital signal.

9. The lighting-dimming device as claimed in claim 1, wherein the combination signal comprises an initial code, an address code, a data code and a parity-check code; the light module is designated with an address and controlled by the dimming module having the corresponding address code.

10. The lighting-dimming device as claimed in claim 1, wherein the cycle of the power being chopped is a complete cycle.

11. The lighting-dimming device as claimed in claim 1, wherein the cycle of the power being chopped is partially cut to form a half cycle.

12. The lighting-dimming device as claimed in claim 1, wherein the cycle of the power being chopped is partially cut in accordance with a required phase angle.
